(19) United States
(12) Patent Application Publication
(10) Pub. No.: US 2014/0279579 A1
(43) Pub. Date: Sep. 18, 2014

(54) System And Method for Preventing Retail Loss

(71) Applicant: Darrell Huntsman, Salt Lake City, UT (US)

(72) Inventor: Darrell Huntsman, Salt Lake City, UT (US)

(21) Appl. No.: 14/210,300

(22) Filed: Mar. 13, 2014

Related U.S. Application Data
(60) Provisional application No. 61/790,357, filed on Mar. 15, 2013.

(51) Int. Cl. G06Q 50/18; G06Q 10/00

(52) U.S. Cl. CPC G06Q 50/182; G06Q 10/00
USPC 705/309

(57) ABSTRACT

A system and method for preventing retail loss is described. The method includes offering a civil remedy in lieu of criminal prosecution to a suspect involved in theft of merchandise; capturing the suspect's information; verifying the suspect's information through a comparison with a database; obtaining an admission of guilt to the theft from the suspect; providing the suspect with life correcting coursework designed to prevent future occurrences of theft by the suspect; and foregoing criminal prosecution of the suspect for the theft upon the suspect's completion of the coursework.

### FIELD OF THE INVENTION

The present invention relates to a system and method for preventing retail loss. More particularly, the present invention relates to a system and method where information from a criminal offender is captured and recorded, the information is processed through an administrative tool and database program, and the offender is given the option of accepting private, civil remedies for following restorative justice principles, including participation in an educational course in behavior modification, instead of the usual criminal remedies associated with theft. The system and method have application to reducing the private and public expenses associated with retail theft.

### BACKGROUND OF THE INVENTION

Retail theft is a significant burden on society. Both private industry and public institutions are threatened from unchecked losses associated with retail theft. Typically, when a shoplifter is discovered by a retailer, the suspect must be apprehended and confined by store personnel while the police are called. The police must travel to the store, investigate the situation, take statements from the retailer and the offender, arrest the offender, and write reports detailing the facts of the incident and the arrest. Once arrested, the offender must then be processed through the legal system. This includes being prosecuted by government attorneys and having the matter fully heard by the criminal court system, including a possible criminal trial. Additionally, the retailer can pursue civil demand and restitution for damages.

The costs associated with apprehending, criminally investigating, and prosecuting retail theft offenders are enormous. There are approximately 150,000 shoplifting offenses committed per day in the Unites States. It is estimated that the burden on taxpayers from law enforcement and court costs associated with these offenses exceeds $130 billion per year. Further, it is estimated that consumers must pay increased prices of approximately $50 billion per year based on the retailers' costs associated with retail loss prevention programs and pressing forward with criminal cases against offenders. There are also lost productivity costs associated with the police being pulled away from other duties, the retailer being forced to catch and punish the offenders, and the offenders being lost in a common cycle of criminal convictions, fewer job opportunities, lack of marketable skills development, hopelessness, and more crime.

There exists a need for a method of preventing and reducing retail losses associated with shoplifting. There further exists a need for providing retail theft offenders with an incentive to choose a more constructive solution through voluntary civil remedies instead of criminal prosecutions. There exists an additional need for providing a method wherein recidivism associated with retail theft offenders is reduced.

### SUMMARY OF THE INVENTION

The present invention provides a novel system and method of preventing retail loss. The system and method comprise a series of steps involving the retailer apprehending the suspect, verifying the suspect's information, assessing the suspect's status as a repeat offender through a private or public database, presenting the suspect with an option to admit guilt and to take an educational course in lieu of an arrest, and tracking the suspect's progress through the educational course.

The present invention provides incentives to a theft suspect to admit guilt and to cooperate in a voluntary educational program designed to habilitate the suspect's criminal tendencies toward theft. The system and method disclosed herein can be used to encourage retail store owners to participate in constructive programs for criminal rehabilitation instead of burdening local police and law enforcement authorities with criminal apprehensions, reporting, and prosecutions. The present invention further provides the useful feature of mobile application, thereby increasing the utility and applicability of the method to a variety of commercial situations.

### BRIEF DESCRIPTION DRAWINGS THE DRAWINGS

FIG. 1 shows a diagram of the system and method according to the present invention.

### DESCRIPTION OF EXAMPLE EMBODIMENT

An embodiment of the system and method of the present disclosure is shown in the diagram of FIG. 1, where a system (100) for preventing retail loss is shown.

According to one embodiment of the disclosure, when a store owner or management team first apprehends a shoplifting suspect, the suspect is given an initial interview (S1) where the suspect is given the choice of cooperating in a civil remedy, which may include an educational course in behavior modification, or, alternatively, being criminally prosecuted for the theft. If the suspect agrees to the civil remedy, the owner proceeds to provide an overview (S2) to the suspect about the alternative civil process instead of the traditional method of initiating a criminal arrest. This overview is preferably presented to the suspect in the form of a short video presentation, which can be displayed on a laptop computer, tablet computer, hand-held computer, or hand-held communication device such as a smart phone or tablet device.

Following the overview of the process step (S2), the owner will proceed with the step of capturing information (S3) from the suspect that will be necessary to the successful implementation of the incentives and educational program. Using a scanning module (120), the owner then captures or records the suspect's identifying information. This information may include the suspect's name, address, contact information, such as telephone numbers and email addresses, fingerprints, drivers license number, social security number, and any other identifier useful to looking up the suspect's information of prior criminal history. The scanning module (120) may include information scanners well-known in the prior art, such as a fingerprint or similar biometric scanner for recording personally identifying information, as well as three-dimensional and two-dimensional scanners for recording drivers license information, SKU data information, social security numbers, and the like. The scanning module (120) may also include a camera for capturing the suspect's still photograph or video image as well as capturing photographs of evidence of the crime and capturing signatures.

After the suspect's information is captured, the suspect's information is entered into database (140) using database entry module (150). The database entry module (150) can comprise a laptop computer, tablet computer, hand-held computer, or hand-held communication device such as a smart phone or tablet device and a database. Database (140) can be either remote or local computerized database. Database entry module (150) is in communication with a database (140) such that the owner can enter and receive information about the suspect. Although the suspect's information can be entered manually into database (140) through database entry module (150), it is preferably transmitted automatically through scanning module (120) to avoid mistaken entry of the suspect's identifying information.

In addition to entering the suspect's identifying information, the owner may also enter incident-specific information into database (140) such as the type of offense, the value of the stolen items, and other details of the event. Database (140) may further be connected to remote third party databases, such as the Lexus-Nexus® database, for searching and obtaining additional information related to the suspect's identification and criminal history. After capturing the suspect's information (S3) and entering or searching the suspect's information in database (140), the owner then performs the step of verifying the suspect's information (S4). This is accomplished through reference to information obtained from database (140). After the suspect's information has been verified, the owner may assess if the suspect is a repeat offender at either the owner's store or at any other store entering information into database (140). If database (140) shows that the suspect is a repeat offender, then the owner has the option of stopping the process and contacting the police or local law enforcement authorities for an immediate criminal prosecution.

In one embodiment of the present invention, scanning module (120), database entry module (150), and the program overview (S2) information are all contained in or connected with the same electronic device. In a preferred embodiment of the present invention, the owner presents the program overview (S2), captures the suspect's information (S3), and verifies the suspect's information (S4) all through the same tablet computer.

Following verification of the suspect's information (S4), an incident report can be created. The incident report can contain evidence of the theft, including photos of the merchandise taken, photographs of the suspect, the suspect's verified information, the suspect's fingerprints, photographs and/or statements of witnesses to the incident, and any other information desired by the merchant.

After obtaining the suspect's information and agreement to proceed with the methods of civil remedy disclosed in the present invention, the owner or merchant then obtains the suspect's voluntary, written admission of guilt (S5) and the suspect's agreement to participate in and to complete corrective education coursework within a specified timeframe (S6). The coursework is the provided to the suspect (S7). Under one embodiment, the timeframe for allowing the suspect to complete the coursework is determined by local standards of the applicable statue of limitations associated with the offense as well as considerations related to the length of the course and the perceived ability of the individual to comprehend and complete the work. It is preferred that the timeframe be at least fifteen days after the incident, preferably thirty days after the incident, and in no event longer than the applicable statue of limitations associated with the offense.

In one embodiment of the present invention, the coursework is offered to the suspect through an online course accessed over the Internet. In this case, the suspect's progress toward completion of the course can be monitored and reported as necessary. For example, if the suspect is found to be a repeat offender, the owner can consider the suspect's progress toward completion of the course arising from a prior incident as one factor in determining whether to abandon the civil remedies and proceed with a criminal arrest in the current incident. As another example, the suspect's level of progress in the coursework can also be considered by prosecuting attorneys should the suspect fail to complete the course. One benefit of offering online coursework is that the interactive nature of the coursework can be an effective tool for customizing the educational concepts for the offender and testing the offender to ensure he is understanding the required concepts.

If the suspect is in default on the coursework, through either failing to complete the course or failing to pay for the course within the noted timeframe, the records of the incident are forwarded to law enforcement or local prosecutors with the suspect's written admission of guilt and a criminal complaint is filed on behalf of the retailer. In another embodiment of the preset invention, a third-party administrator monitors the suspect's progress in and payment for the corrective education coursework. The third-party administrator, or corrective education administrator (CEA), has access to database (140) and a copy of the suspect's written admission of guilt and his agreement to complete the coursework. The CEA, on behalf of the owner, will proceed to forward this information to law enforcement officials or to local prosecutors in the event of default by the suspect.

According to one embodiment of the present invention, database (140) can be used to promulgate reports to the owner on retail theft activity across a single or even multiple stores, as well as to promulgate reports on local area and even national retail theft activity. The information in database (140) can also be used to report on the effectiveness of a store's loss prevention efforts and recidivism of suspects in specific or in general.

According to the present invention, the corrective education coursework offered to the suspect may include educational material on cognitive restructuring and life skills. For example, the educational material can educate the suspect about recognizing criminal behavior, respecting others and their property, and understanding the negative consequences of crime on the suspect, his family, and his community. In addition, the material can present information on understanding the court process and what life in prison is like. Further, the educational material can teach life skills such as understanding the importance of a job, how to write a resume, and how to interview for a job. It can also teach the suspect how to make and keep a budget as well as the effects of substance abuse and the importance of good mental and physical health.

In another embodiment of the invention, the merchant can notify third parties, including private store security firms, of the incident through automatic communications of the incident report and any updates to related databases associated with the incident.

The loss prevention management system of the present invention allows more effective quality control of merchant loss prevention programs. Further, information associated with the incident can be used in processes of data mining and analytics to reveal merchant loss trends, which merchandise is more susceptible to theft, what type of individuals are more prone to theft in retail settings, and even to predict the times of the day, week, month, or year that are more likely to reveal criminal theft behavior.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A merchandise loss prevention method comprising:
offering a civil remedy in lieu of criminal prosecution to a suspect involved in theft of merchandise;
capturing the suspect's information;
verifying the suspect's information through a comparison with a database;
obtaining an admission of guilt to the theft from the suspect;
providing the suspect with life correcting coursework designed to prevent future occurrences of theft by the suspect; and
foregoing criminal prosecution of the suspect for the theft upon the suspect's completion of the coursework.

2. The method of claim 1, wherein offering the civil remedy further comprises providing a program overview of the civil remedy being offered.

3. The method of claim 2, wherein providing the program overview comprises presenting the suspect with a visual representation of terms of the civil remedy.

4. The method of claim 1, wherein capturing the suspect's information comprises scanning biometric information of the suspect.

5. The method of claim 4, further comprising entering the suspect's information into a database.

6. The method of claim 4, wherein verifying the suspect's information comprises comparing the suspect's information with information in the database to determine accuracy of the suspect's information.

7. The method of claim 1, further comprising creating an incident report of the theft of the merchandise.

8. The method of claim 1, wherein providing the suspect with life correcting coursework comprises providing the suspect with access to an online course with interactive features.

9. The method of claim 8, further comprising providing a corrective education administrator to monitor the suspect's progress in the coursework.

10. The method of claim 9, wherein providing the corrective education administrator comprises providing an administrator to initiate criminal prosecution for the theft based on failure of the suspect to complete the coursework.

11. A merchandise loss prevention system comprising:
a program overview device to present a civil remedy to a suspect involved in an incident of theft of merchandise;
an information capturing device to record data associated with the incident;
a data entry device to manually enter data associated with the incident;
a verification component to verify any data obtained from the suspect; and
a coursework program to teach the suspect life skills that will assist the suspect in not engaging in future theft.

12. The system of claim 11, wherein the program overview device comprises a viewing screen and audio speakers to visually and audibly present terms of the civil remedy to the suspect.

13. The system of claim 12, wherein the program overview device comprises a hand-held tablet computer.

14. The system of claim 11, wherein the information capturing device is selected from one or more of a biometric scanner, a document scanner, a video camera, and a camera.

15. The system of claim 14, wherein the information capturing device is operably connected with a tablet computer.

16. The system of claim 11, wherein the data entry device comprises a tablet computer.

17. The system of claim 11, wherein the program overview device, the information capture device, the data entry device, and the verification component are operably interconnected.

18. The system of claim 17, wherein interconnectivity of the devices and component are facilitated through a tablet computer.

19. The system of claim 11, wherein the coursework program comprises online software to educate the suspect on life skills.

20. The system of claim 19, wherein the online software comprises reporting features for communicating progress of the suspect to a corrective education administrator.
